(19) United States
(12) Patent Application Publication
(10) Pub. No.: US 2006/0115383 A1
(43) Pub. Date: Jun. 1, 2006

(54) Flow through well plate surface sorption extarction

(75) Inventor: Robert H. Wohleb, Ferndale, CA (US)

Correspondence Address: CRAIN, CATON & JAMES, FIVE HOUSTON CENTER, 1401 MCKINNEY, 17TH FLOOR, HOUSTON, TX, 77010, US

(73) Assignee: Vici Gig Harbor Group, Inc.

(21) Appl. No.: 11/325,188

(22) Filed: Jan. 4, 2006

Related U.S. Application Data
(63) Continuation-in-part of application No. 10/663,955, filed on Sep. 16, 2003.
(60) Provisional application No. 60/646,946, filed on Jan. 25, 2005.

(51) Int. Cl. B01L 3/00

(52) U.S. Cl. 422/101; 422/102

(57) ABSTRACT

A device for extracting an analyte from a sample matrix comprises a flow through well plate, each well which is coated with a sorbent material. A method for extracting an analyte from a sample matrix includes exposing the sample to the sorbent coating of the well plate. The sorption-coated well plate retaining the analyte may then be stored or transported to a lab for further analysis.

### CROSS-REFERENCE TO RELATED APPLICATIONS

This application is a continuation-in-part under 37 CFR 1.53(b) to application Ser. No. 10/663,955, “Direct Vial Surface Sorbent Micro Extraction Device and Method,” filed on Sep. 16, 2003 by Robert Wohleb and claims priority to U.S. Patent Application 60/646,946 filed Jan. 25, 2005 entitled “Flow Through Well Plate Surface Sorption Extraction”

### STATEMENT REGARDING FEDERALLY-SPONSORED RESEARCH OR DEVELOPMENT

None.

### BACKGROUND OF THE INVENTION

1. Field of the Invention

This invention relates to the extraction and collection of one or more analytes by a sorption process. Specifically, this invention relates to a device and method for performing well plate surface sorption extraction.

2. Description of the Related Art

A well plate, also known as microplate or multiwell plate, is a flat plate/tray/panel/dish with multiple wells (test tubes). The number of “test tubes”, more commonly known as “wells” in the most common format is 96. Well counts per plate currently go as high as 9600. Wells may have square or round walls and may have bottoms of various shapes including flat, curved, conical and flow through. Well plates are made from a variety of plastics and polymers. Well plates are available with filter bottoms and packings of standard solid phase media for solid phase extraction. Solid phase extraction (SPE) is often used to extract an analyte prior to analysis by chromatography. SPE well plates come in a fixed format where all wells have a fixed volume and fixed amount of sorbent. Flexible plates are also available where each well or SPE cartridge is removable from it's base plate.

Fluids are aspirated in and out of a well by syringe or pipette. Alternatively fluids are allowed to drain out the bottom (flow through) or are forced out the bottom where they may be collected in another plate.

For solid phase extraction (SPE), each well of the standard media plate currently available is an adaptation of SPE cartridge technology. Each well contains either a packing of SPE media, particle loaded membranes or a monolithic bed. Standard well plate SPE typically requires the same extraction steps as SPE cartridges including a sorbent cleaning, a sorbent conditioning, sample extraction, sorbent washing and extract elution. Well plate SPE requires either a vacuum or a pressure system to cause the sample to flow through the SPE media. Additional plates are required to catch the extracted compounds of interest, also known as the analyte, and solvent eluate.

It is known in the art to use a sorbent to extract an analyte from a sample solution. The analyte is later extracted from the sorbent by thermal desorption or by back extracting with a small amount of organic solvent. Sorption materials are usually homogenous, non-porous materials that are above their glass transition point (T_{g}) and in which the analyte can dissolve. The compounds of interest extracted from the sample may be removed for analysis by thermal desorption or solvent extraction.

It would be an improvement to the art to have coated well plates by which the extraction may be directly performed and the components of interest, the analyte, conveniently manipulated for further chemistry.

### BRIEF SUMMARY OF THE INVENTION

The present invention comprises a device and method for well plate surface sorption extraction.

Accordingly, the objects of my invention are to provide, inter alia, a single step surface sorption extraction system that:

minimizes the amount of solvent used;

eliminates the need for sorbent conditioning;

has greater reproducibility than well plate SPE;

readily automatable

better handles viscous samples; and

reduces or eliminates sample cross contamination.

This invention is a sorption well plate that can be used for the extraction of a sample, or analyte, from a sample matrix and a method of using the sorption well plate to perform the extraction. In this invention the well has a bottom with an orifice through which fluids may drain. Preferably, the sorption well of the plate has an orifice coated with sorptive material.

The sample is placed in a well and allowed to drain past the sorptive surface where the compounds of interest are extracted from the sample by partitioning into the sorptive coating. The extracted sample is typically captured by a collection plate.

After partitioning of the sample into the sorptive material, a new collection plate is installed. When desired, which may be at a later time, an elution solvent is added to the sorption well and allowed to drain into the collection plate thereby extracting the compounds of interest, the analyte, from the sorptive coating. The solvent containing the compounds of interest, the analyte, may be removed from the collection well for further chemistry or the well may be sealed.

### BRIEF DESCRIPTION OF THE DRAWINGS

FIG. 1 is a cross-sectional view of a well plate with a sorption coating.

FIG. 2 is a cross-sectional view of a standard orifice with a sorption coating.

FIG. 3 is a cross-sectional view of a multi holed orifice with a sorption coating

FIG. 4 is a cross-sectional view of a corrugated orifice with a sorption coating.

### DESCRIPTION OF THE INVENTION

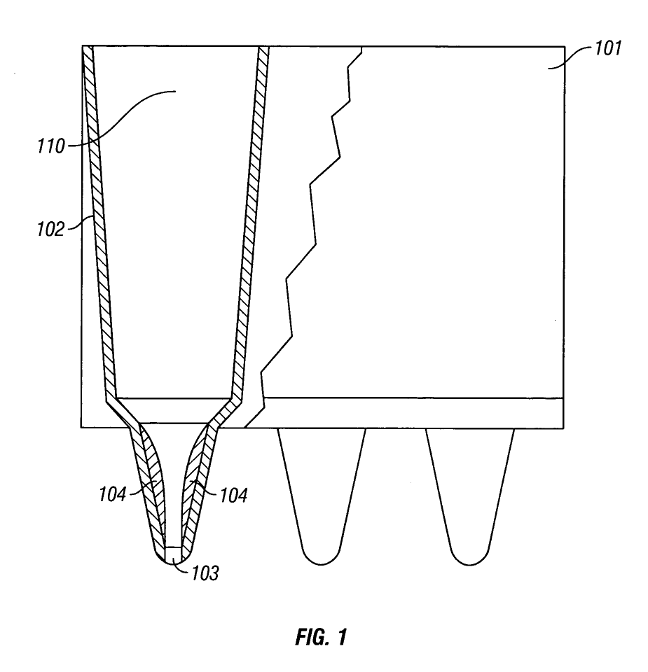

Referring to FIG. 1, the preferred embodiment of the well plate surface sorption extraction device.

Referring to FIG. 1 sorption well plate 101 is made from a rigid, nonreactive material, such as polypropylene. In the preferred embodiment, sorption well 110 has a cylindrically-shaped interior wall 102 with a circular-shaped bottom orifice 103. A sorptive coating 104 is applied to well 110. The sorptive coating 104 may be applied on the well interior wall 102 or the bottom orifice 103 or both.

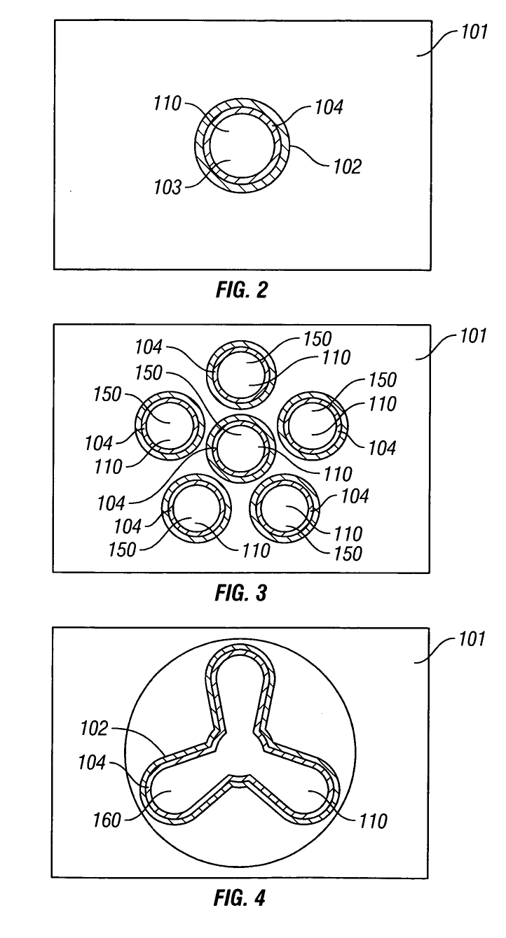

The bottom orifice may be circular in shape as in FIG. 2 or alternatively may have multiple orifices 150 as shown in FIG. 3 or may have a convoluted shape 160 as shown in FIG. 4. The bottom orifice shape and length may be optimized to give the most surface area and least back pressure while exhibiting the smallest wall to wall distance.

In the preferred embodiment, the sorptive coating 104 is a hydrophobic coating, such as an immobilized polysiloxane, for example polydimethylsiloxane (PDMS), which contains only methyl functional groups. The name “siloxane” is based on the Si—O—Si unit and has found acceptance in scientific nomenclature. Polysiloxanes are polymers with repeating siloxane units. Each repeating siloxane unit contains two functional groups attached (e.g. dimethyl) which may, or may not, be of the same type of functional group. A functional group is an atom or combination of atoms which gives a polymer its distinctive and sorptive qualities. A polysiloxane of 50 repeating units would therefore have 100 methyl groups, whereas a siloxane unit with two different types of groups such as phenylmethyl would have 50 of each “type” of functional group in the polysiloxane. The term ‘functional’ group is linked to the concept of a homologous series. A homologous series is a group of molecules with the same general formula and the same functional group. All molecules in the series therefore have similar physical and chemical properties (albeit with trends e.g. increased boiling point with increased chain length). It is known in the art that immobilized polysiloxanes that contain other types of functional groups, may be used as sorbents. These include immobilized polysiloxanes containing phenyl or trifluoropropyl functional groups. Examples of these polysiloxanes include diphenylsiloxane-dimethylsiloxane copolymers and trifluoropropylmethylsiloxanes. For more selective sorption applications the immobilized polysiloxane may contain other types of functional groups including alkyl, alkenyl, alkynyl, aryl, alkylaryl, alkenylaryl, alkynylaryl, haloalkyl or haloaryl. A polysiloxane may contain said types of functional groups in any combination. The selection of a certain type of functional group or groups permits the partitioning of a particular analyte or analytes from the sample. The polysiloxane coating may be a polymer, a copolymer or a combination of polymers.

Alternatively, sorptive coating 104 may be (1) a porous layer, such as a derivatized etched surface, (2) other immobilized polymers that are above their glass transition temperatures such as poly butadiene, (3) an immobilized porous polymer, such as divinylbenzene, ethyleneglycoldimethacrylate, and copolymers of divinylbenzene and ethyleneglycoldimethacrylate, polyethyleneimine, acrylonitrile, n-vinyl-2-pyrollidinone or 4-vinyl-pyridine, (4) a sol-gel or (5) an immobilized adsorbent such as graphatized carbon black. Sorptive coating 104 may be any one of the coatings described or a combination of two or more of the alternative coatings. The selection of the coating or coatings by one skilled in the art is dependent upon the analyte or analytes to be partitioned from the sample.

The extraction process comprises placing a sample in the surface sorption well 110. This is typically accomplished with a syringe or pipettor (not shown). The sample is then allowed to drain into a collection device or alternatively pulled through by vacuum or pushed through by a pressurized gas. When back-extraction of the analyte or analytes is desired, a predetermined amount of elution solvent (not shown) is measured into surface sorption well 110 and allowed to drain into a collection device such that the compounds of interest are extracted. The collected analyte may be analyzed by gas chromatography, high performance liquid chromatography or other analytical instruments. Alternatively, the collected analyte may be stored or manipulated for further chemistry.

In some cases the volume of sample is greater than the volume of surface sorption well 110. Surface sorption well 110 is then repeatedly filled with a portion, not exceeding well volume, of the solution containing analytes to be extracted. After the portion has drained through the orifice, additional portions are added until the entire analyte has been extracted. A predetermined amount of elution solvent (not shown) is measured into surface sorption well 110 in the same manner as above and allowed to drain into a collection device as above. The foregoing disclosure and description of the invention is illustrative and explanatory thereof. Various changes in the details of the illustrated construction may be made within the scope of the appended claims without departing from the spirit of the invention. The present invention should only be limited by the following claims and their legal equivalents.

What is claimed is:

1. A device for the collection and extraction of at least one analyte within a sample, said device comprising:
a well plate,
said well plate having at least one well;
said at least one well having a first end;
said at least one well having an interior;
said at least one well having an orifice therethrough; and
a sorptive coating adhered to said interior of said well

2. The device of claim 1 wherein:
said orifice having an irregular shape.

3. The device of claim 1 wherein said sorption well is polypropylene or other polymers.

4. The device of claim 1 wherein:
said sorptive coating is an immobilized polysiloxane polymer containing at least one functional group selected from the group consisting of alkyl, alkenyl, alkynyl, aryl, alkylaryl, alkenylaryl, alkynylaryl, haloalkyl or and haloaryl.

5. The device of claim 1 wherein:
said sorptive coating is an immobilized polysiloxane polymer having at least two functional groups selected from the group consisting of alkyl, alkenyl, alkynyl, aryl, alkylaryl, alkenylaryl, alkynylaryl, haloalkyl and haloaryl

6. The device of claim 1, wherein said sorptive coating is an immobilized porous polymer.

7. The device of claim 1, wherein said immobilized porous polymer is selected from the group consisting of: divinylbenzene, ethyleneglycoldimethacrylate, polyethyleneimine, acrylonitrile, n-vinyl-2-pyrollidinone, and 4-vinyl-pyridine.

8. The device of claim 1, wherein said sorptive coating comprises a sol-gel coating.

9. The device of claim 1, wherein said sorptive coating is a polymer existing above its glass transition temperature.

10. A method for performing well plate surface sorption extraction of analytes from a sample comprising:
adhering a sorptive coating to the interior of at least one well of a well plate;
said well plate having at least one well;
said at least one well having a first end;
said at least one well having an interior;
said at least one well having an orifice therethrough
introducing a liquid sample, said liquid sample containing at least one analyte susceptible to sorption by said sorptive coating into said well;
contacting said liquid sample to said sorptive coating;
allowing said liquid sample to exit said well through said orifice;
introducing an elution solvent into said well, said elution solvent causing said at least one analyte to be separated from said sorptive coating;
allowing said elution solvent and said at least one analyte to exit said well; and
collecting said elution solvent and said at least one analyte.
